(19) United States
(12) Patent Application Publication
(10) Pub. No.: US 2021/0232357 A1
(43) Pub. Date: Jul. 29, 2021

(54) MULTICOMPONENT CONTENT SYSTEM INTEGRATING PHYSICAL STRUCTURES WITH DIGITAL MEDIA

(71) Applicant: Thomas Maher, Gilbert, AZ (US)

(72) Inventor: Thomas Maher, Gilbert, AZ (US)

(21) Appl. No.: 17/158,514

(22) Filed: Jan. 26, 2021

Related U.S. Application Data
(60) Provisional application No. 62/965,893, filed on Jan. 26, 2020.

(51) Int. Cl. G06F 3/14; B42D 1/00; G06F 3/02

(52) U.S. Cl. CPC G06F 3/14; G06F 3/0202; B42D 1/007

(57) ABSTRACT

The disclosure includes a multi-media book system. An embodiment of the system can include a book system. The book system includes both an open and closed configuration. The book system includes a cover device and a book device. The book device is configured to fit inside of the cover device. Both the cover device and the book device are configured to function like a book and can include pages. These pages can be coupled to a binding or spine of the book device, separate from the cover device. The cover device includes a cover interior surface and a cover exterior surface. The book device includes a book interior surface and a book exterior surface. The book exterior surface is configured to mate with the cover interior surface via a magnetic coupling.

### TECHNICAL FIELD

Embodiments of this disclosure relate generally to a book display system, and in particular a system for coupling multiple books and integrating displayed media.

### BACKGROUND

The primary purpose of scrapbooking is to preserve memories for future generations, but a secondary purpose often is to exercise creativity to display memories in a scrapbook. The process of scrapbooking includes combining the physical content into the physical device. There is no digital imaging or audio in current scrapbooking or other personal memory collection. In the past few years, digital imaging (such as photos or video) and digital audio have become mainstream. Today, collecting video and audio content is just as common as taking photos and scrapbooking has not been able to accommodate for video and audio content as it cannot be printed and pasted like images. The end users of the scrapbook/memory device want to remember the movements and point of view they once had while creating the memories, not just one frame.

Scrapbooks, and other interactive book and memory products, are typically one-piece items (cover and internal paper combined). If damages occur, the user is forced to keep the product and/or resort to getting a brand new one; thus, forfeiting their progress and starting over.

Accordingly, there remains a need for an improved comprehensive and efficient way to address the problem. This need and other needs are satisfied by the various aspects of the present disclosure.

### SUMMARY

Some or all of the above needs and/or problems may be addressed by certain embodiments of the disclosure. Certain embodiments of the disclosure can include a multimedia book display system. The disclosure includes a multi-media book system. The book system includes both an open and closed configuration. The book system includes a cover device and a book device. The book device is configured to fit inside of the cover device. Both the cover device and the book device are configured to function like a book and can include pages. These pages are coupled to a binding or spine the book device, separate from the spine of the cover device. The cover device includes a cover interior surface and a cover exterior surface. The book device includes a book interior surface and a book exterior surface. The book exterior surface is configured to mate with the cover interior surface via a magnetic coupling.

Other embodiments, features, and aspects of the disclosure are described in detail herein and are considered a part of the claimed disclosure. Other embodiments, features, and aspects can be understood with reference to the following detailed description, accompanying drawings and claims.

### BRIEF DESCRIPTION OF THE DRAWINGS

The detailed description is set forth with reference to the accompanying drawings, which are not necessarily drawn to scale.

FIG. 1 depicts a top view of the book system of the disclosure in an open configuration.

FIG. 2 depicts an isometric view of the system in a closed configuration of FIG. 1.

FIG. 3 depicts a top exterior view of a cover device in an open configuration.

FIG. 4 depicts a top interior view of the cover device.

FIG. 5 depicts an isometric exterior view of the book device in a closed configuration.

FIG. 6 depicts a top exterior view of the book device in an open configuration.

FIG. 7 depicts side exploded view of the book system in FIG. 1.

FIG. 8 depicts an isometric view of an alternative embodiment of the cover device in a closed configuration.

FIG. 9 depicts a block diagram of the electrical components embedded in the cover device.

### DETAILED DESCRIPTION OF THE DISCLOSURE

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The following description is provided as an enabling teaching of the disclosed articles, systems, and methods in their best, currently known embodiments. To this end, those skilled in the relevant art will recognize and appreciate that many changes can be made to the various aspects of the articles, systems, and methods described herein, while still obtaining the beneficial results of the disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “a gasket” can include two or more such gaskets unless the context indicates otherwise.

As used throughout, “substantially” with respect to a measure can refer to a range of values comprising +/−10 degrees or +/−10 percent. For example, substantially orthogonal, normal, or parallel can include embodiments, where the referenced components are oriented +/−10 degrees of being classified as orthogonal, normal, or parallel respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

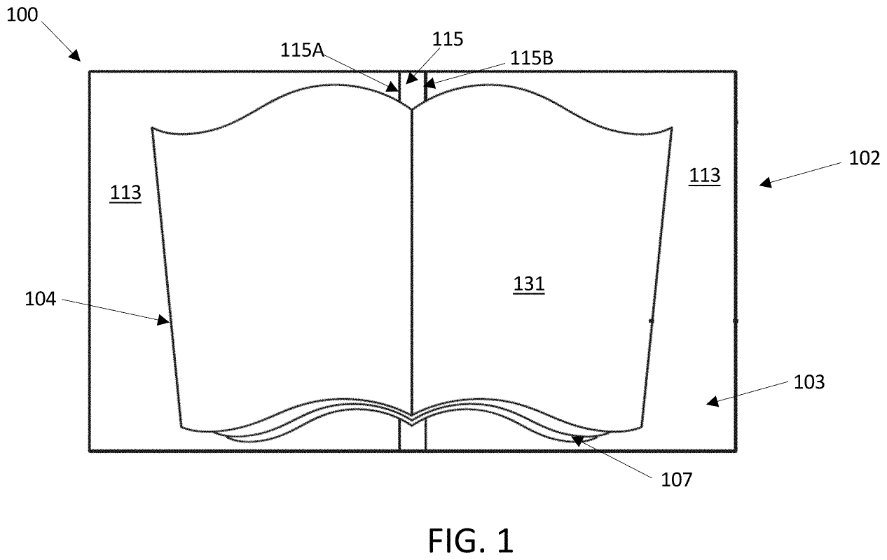

FIG. 1 depicts a top view of the book system 100. The book system 100 includes the cover device 102 and the book device 104. In one aspect the cover device 102 can comprise a cover suitable for protecting a book. Functioning as a cover, the cover device 102 can be configured to protect interior contents, such as the book device 104, from the elements. In one aspect the cover device 102 can be comprised of two cover panels and a cover spine. The cover panels 113 can comprise left and right rectangular members. In other aspects, the cover panels 113 can be shaped in other geometrical shapes such as polygons, curved shapes or combination of geometrical shapes. In one aspect, the cover spine 115 can comprise a rectangular member. In other aspects, the cover spine 115 can comprise other geometric shapes. The cover device 102 can be configured such that the cover panels 113 can be coupled to opposite sides 115 A-B of the cover spine 115. Further, the combined area dimensions of the cover spine 115 and cover panels 113 define the surface area of the exterior surface (not shown) and interior surface 103 of the cover device 102.

The cover device 102 can be structured to transition from an open configuration to a closed configuration by rotating the cover panels 113 relative to the cover spine 115, resulting in an angle between the two cover panels. The closed configuration for the cover device 102 occurs when the cover panels 113 come to rest in parallel planes, resulting in no angle between the two cover panels. In one aspect, the dimensions of the cover device interior surface 103 can be greater than the dimensions of the book device exterior surface 109. Further, in the closed configuration, the greater dimensions of the cover device can allow the cover device 102 to encompass the book device 104.

In a further aspect, the cover device 102 or the book device 104 can include a rigid material. The rigidity of the cover device 102 or book device 104 can provide overall support and structure to the book system 100. In one aspect, either the cover device 102 or book device 104 comprise a durable material such as leather. In another aspect, either the cover device 102 or book device 104 can comprise a paper product with a latex, plastic, or epoxy coating to increase durability. The structure and support of either the cover device 102 or book device 104 device can also be enhanced with rigid materials such as a metallic member, corrugated cardboard, or foam board. Other materials to provide rigidity are also considered.

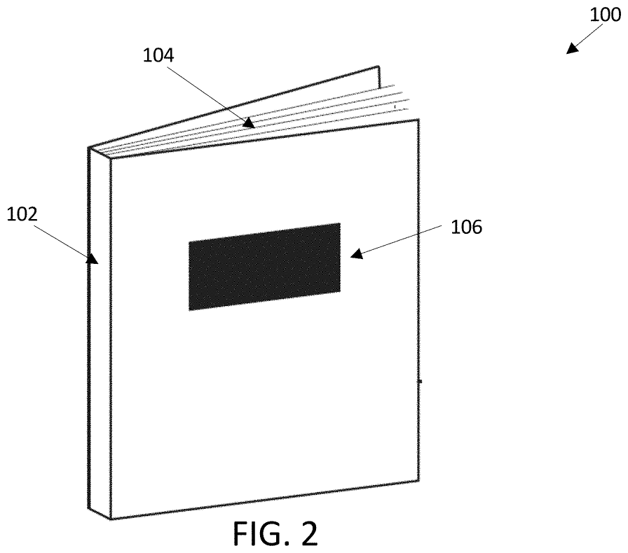

Further, embodiments of the cover device 102 can include a metallic member to facilitate magnetic coupling to the book device 104. In yet a further aspect, both the cover device 102 and the book device 104 can comprise pages 131. The pages 131 can be coupled to the interior surface 103 of the cover device or the interior surface 107 of the book device 104. FIG. 2 depicts the system 100 in a closed configuration showing the cover device 102 encompassing the book device 104. In a further aspect, the system 100 can include a display device 106 that can be embedded in the exterior surface of the cover device 102.

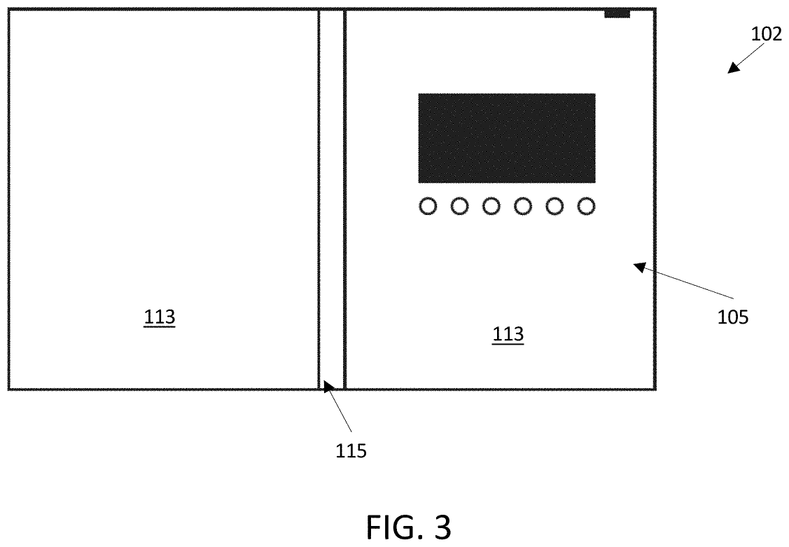

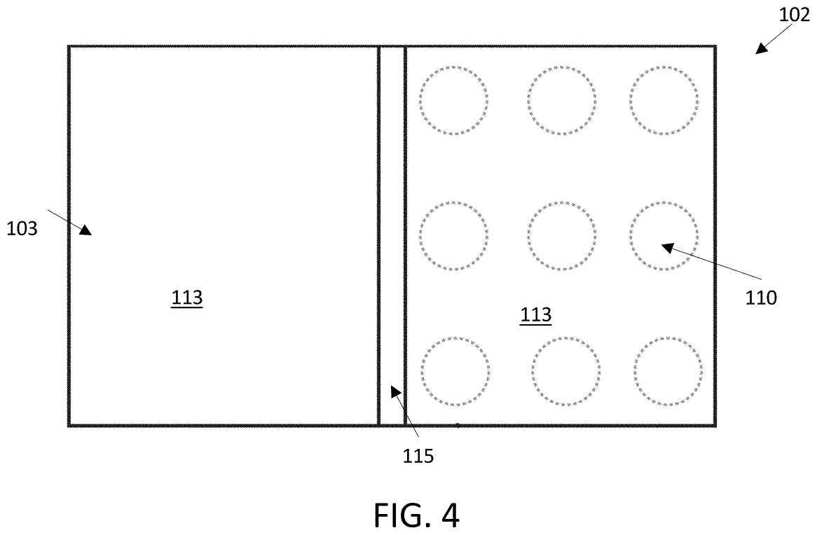

FIG. 3 and FIG. 4 depicts the cover device 102 in an open configuration. As shown in FIG. 3, the exterior surface 105 of the cover device spans the cover panels 113 and cover spine 115 that joins the two cover panels. In a further aspect, the interior surface 103 of the cover device 102 can include a magnet 110. For example, the magnet 110 can be located in the interior surface 103, embedded in a cover panel 113. In another embodiment, the interior surface 103 of the cover device can include a metallic member. Similar to the magnet, the metallic member can facilitate a magnetic coupling between the cover device 102 and the book device 104 when an exterior surface 109 of the book device comprises a magnet. Cover panels 113 can have sufficient thickness to embed the magnet 110 in the cover panel, while allowing the magnet to be flush or below the interior surface 103 of the cover device. The bottom side of the exterior surface couples with the top side of the cover panel so that the present invention provides an easy system to remove and add an inner book.

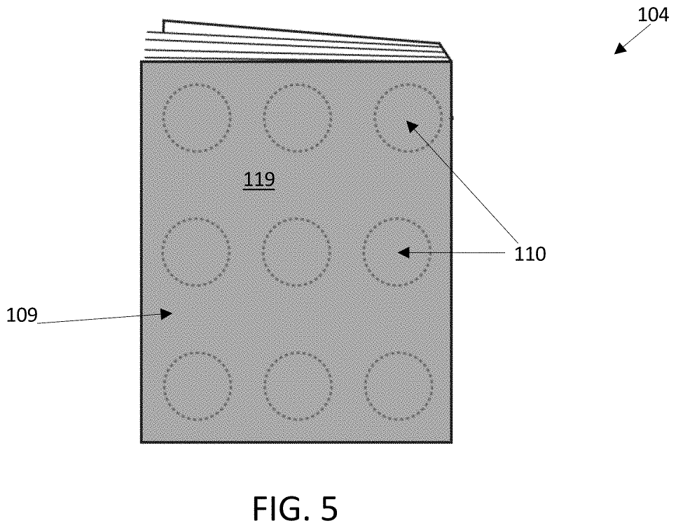

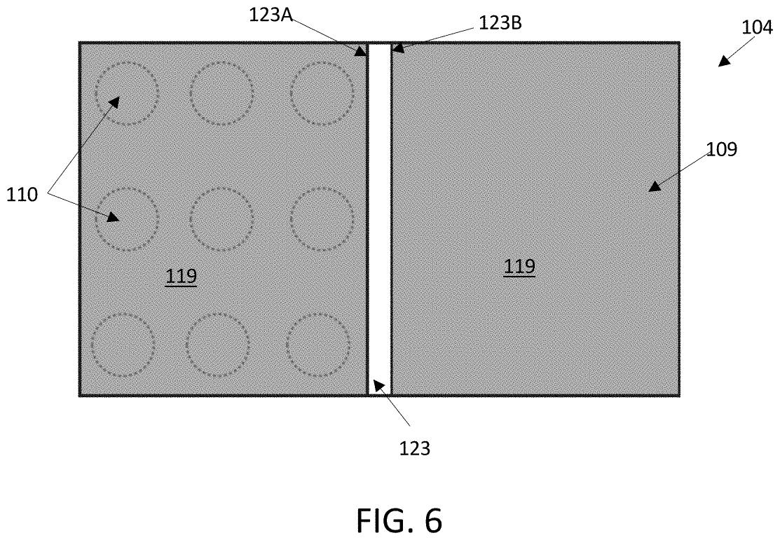

As shown in FIG. 5 and FIG. 6, the book device 104 can be configured in an open and closed configuration. In one aspect, the book device can be comprised of two book panels 119 and a book spine 123. The book panels 119 can comprise rectangular members. In other aspects, the book panels 119, can comprise other geometric shapes, including but not limited to: squares, rhombuses, circles, or combination of geometric shapes. The book spine 123 can comprise a rectangular member. In other aspects, the book spine 123 can comprise other geometric shapes. The book device 104 can be configured such that the book panels 119 can be coupled to opposite sides 123 A-B of the book spine 123. Further, the combined area dimensions of the book spine 123 and book panels 119 define the surface area of the exterior surface 109 and interior surface (not shown) 107 of the book device 104.

Similar to the cover device 102, the book device 104 can structured to transition from an open configuration to a closed configuration by rotating the book panels 119 relative to the book spine 123, resulting in an angle between the two book panels. The closed configuration for the book device 104 occurs when the book panels 119 come to rest in parallel planes, resulting in no angle between the two book panels. In an alternative embodiment, the book device 104 can comprise two book panels 119. In a further aspect, the book panels 119 can be coupled along an edge of each book panel to allow the two panels to rotate relative to each other in the absence of a book spine 123. Similarly, in an alternative embodiment, the cover device 102 can comprise two cover panels 113. In a further aspect, the cover panels 113 can be coupled along an edge of each cover panel to allow the two cover panels to rotate relative to each other in the absence of a cover spine 115. The present invention features the outer cover having its own spine that is unique from the spine of the book device.

Similar to the cover device 102, the book device 104 can also include magnets 110. In as aspect, the magnets 110 can be located in the exterior surface 109 of the book device. In yet another aspect, the exterior surface 109 of the book device 104 can also include a metallic member to also aid in the magnetic coupling between the cover device 102 in the book device 104. Book panels 119 can have sufficient thickness to embed the magnet 110 in the book panel, while allowing the magnet to be flush or below the exterior surface 109 of the book device 104. As shown in FIG. 5 and FIG. 6, at least one of the book panels 119 can include a plurality of magnets 110. The placement of the magnets 110 embedded in the surfaces of the cover device 102 and the book device 104 can be placed in various configurations. For example, the magnets can be uniformly spaced across the surface area of a cover panel 113 or book panel 119. In other aspects, the magnets can be placed in corners of the cover panel 113 or book panel 119 as a method of securing the edges of the respective panels. However, additional spatial arrangements of magnets 110 are considered.

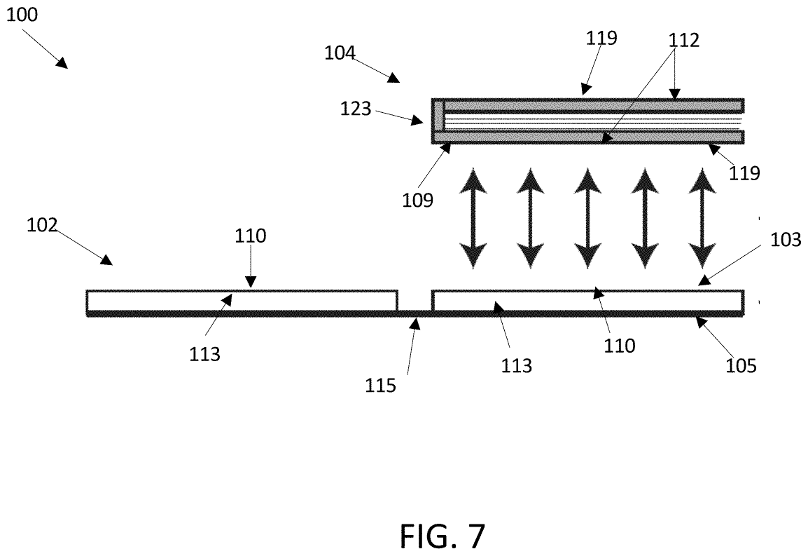

During coupling, the user can lower the book device 104 to mate with the cover device 102. As shown in FIG. 7, The cover device 102 can be oriented in the open configuration to receive the book device 104 for coupling. To facilitate easier alignment during coupling, the book device 104 can be oriented in a closed configuration and lowered to engage to the book device exterior surface 109. Then, the exterior surface 109 of the book panel 119 can engage and couple with the interior surface 103 of the cover panel 113. The user can also disengage the cover device 102 from the book device 104 by raising the book device along the same direction. In yet a further aspect, the magnets 110 used in the magnetic coupling can be of sufficient strength to provide a secure engagement, while also allowing the user to engage/disengage by pushing/pulling at an angle. When both the cover device 102 and the book device 104 comprise a magnet, a primary magnet 110 can be embedded in cover panel 113, and a mating magnet 112 can be embedded in book panel 119. Further, the polarity of the primary magnet and respective mating magnet can be opposing to facilitate a magnetic coupling when the primary magnet 110 and mating magnet 112 are placed in proximity to each other.

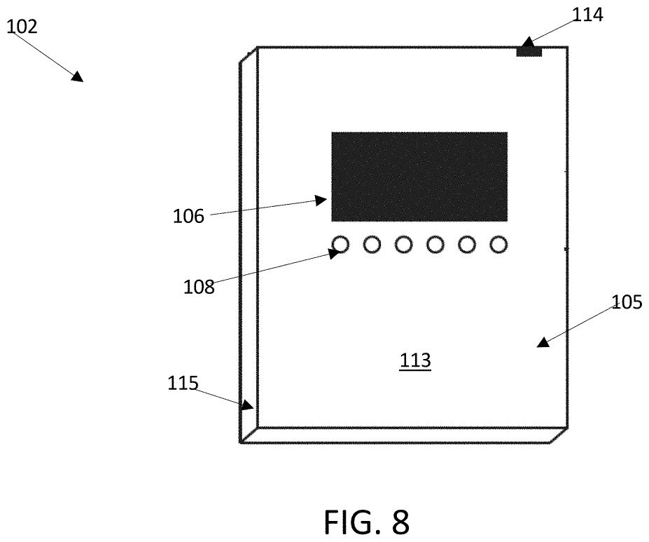

As shown in FIG. 8, the exterior surface 105 of the cover device 102 can include a display device 106. The display device 106 can be screen used to exhibit any visual images that the user wants to provide for display. In a further aspect, the display device 106 can be a graphical user interface (GUI) wherein the user is able to also provide inputs via buttons 108. In a further aspect the display device 106 can be a touch screen display, allowing the user to directly manipulate the display device 106. In a further aspect, the display device 106 can also include speakers to provide audio output from the display device 106. In yet a further aspect, display device 106 can comprise a processor (not shown) to provide additional capabilities for the display device. Input and data transfer to the display device can be provided via a charging port 114. In one aspect, the charging port 114 can be a direct charge, USB type A, USB type C, or Lightning™ type port. The display device 106 can be configured to be on the inside portion of the cover device or the back area of the cover device.

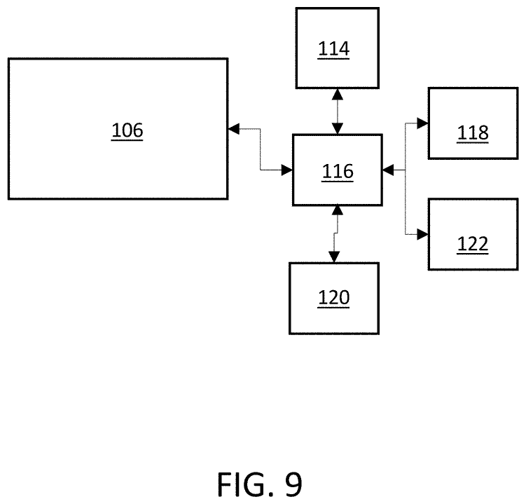

FIG. 9 depicts a block diagram of the display device and supporting electrical components. The display device 106 can be coupled to a processor 116. The processor 116 can be a central processing unit configured to run an operating system, receive inputs from the buttons 108 and/or communicate instructions to other electrical components that support the display device 106. The supporting electrical components can also include a memory 118. The memory 118 can be a storage medium used for storing data, such as: the operating system, images for display, or audio files. The electrical components can also include a battery 120. The battery 120 can be used to provide electrical power to the electrical components of the system 100. In a further aspect, the battery 120 can be rechargeable, such as a Nickel Cadmium or Lithium-Ion type batteries. The electrical charge for the battery 120 can be provided via the charging port 114. The charging port 114 can also be used to provide a communication port to exchange data between an external device and the system100. In one aspect, the charging port 114 can be a USB type A, USB type C, or Lightning™ type connection. The electrical components can also include an antennae/transmitter hub 122. The antennae/transmitter hub can facilitate data communication wirelessly or via remote control. In a further aspect the antennae/transmitter hub also facilitate Bluetooth™ communication with external devices and external computing systems or applications.

While the disclosure has been described in connection with what is presently considered to be the most practical and various embodiments, it is to be understood that the disclosure is not to be limited to the disclosed embodiments, but on the contrary, is intended to cover various modifications and equivalent arrangements included within the spirit and scope of the appended claims.

This written description uses examples to disclose the disclosure, including the best mode, and also to enable any person skilled in the art to practice the disclosure, including making and using any devices or systems and performing any incorporated methods. The patentable scope of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A book system comprising an open and closed configuration, wherein the book system comprises:
a cover device, comprising:
a cover interior surface, and
a cover exterior surface; and
a book device, comprising:
a book interior surface, and
a book exterior surface, wherein the book exterior surface is configured to mate with the cover interior surface via a magnetic coupling.

2. The book system of claim 1, wherein the magnetic coupling comprises:
at least one primary magnet located adjacent to the cover interior surface, and
at least one mating magnet located adjacent to the book exterior surface and configured to couple to the at least one primary magnet.

3. The book system of claim 1, wherein the cover device has a cover device spine separate from a book device spine.

4. The book system of claim 1 wherein a first surface area defined by the cover interior surface is greater than a second surface area defined by the book exterior surface.

5. The book system of claim 4, wherein the cover interior surface encompasses the book exterior surface in a closed configuration.

6. The book system of claim 1, wherein at least one of the cover interior surface or the cover exterior surface is rigid.

7. The book system of claim 1, wherein at least one of the book interior surface or the book exterior surface is rigid.

8. The book system of claim 1, wherein the cover exterior surface comprises a display device.

9. The book system of claim 8, wherein the display device comprises a graphical user interface and processor.

10. The book system of claim 1, wherein a bottom surface of the book exterior surface of the book device mates with the top surface of the cover interior surface.
